(19) United States
(12) Patent Application Publication
(10) Pub. No.: US 2020/0371532 A1
(43) Pub. Date: Nov. 26, 2020

(54) INFORMATION PROCESSING DEVICE, AUTONOMOUS VEHICLE, INFORMATION PROCESSING METHOD AND PROGRAM

(71) Applicant: TOYOTA JIDOSHA KABUSHIKI KAISHA, Toyota-shi (JP)

(72) Inventors: Akitoshi JIKUMARU, Nisshin-shi (JP); Atsuko KOBAYASHI, Nagoya-shi (JP); Kenji FUJIHARA, Nagoya-shi (JP); Takashi YAMAZAKI, Nagoya-shi (JP); Mizuki KIUCHI, Toyota-shi (JP); Masayuki GOTO, Nagoya-shi (JP)

(73) Assignee: TOYOTA JIDOSHA KABUSHIKI KAISHA, Toyota-shi (JP)

(21) Appl. No.: 16/822,205

(22) Filed: Mar. 18, 2020

(30) Foreign Application Priority Data
May 22, 2019 (JP) 2019-096229

(51) Int. Cl. G05D 1/02; G01C 21/36

(52) U.S. Cl. CPC G05D 1/0285; G01C 21/367; G05D 1/0223

(57) ABSTRACT

An information processing device includes a control unit that executes: generating a traveling plan for an autonomous vehicle, the traveling plan including a traveling route and a traveling schedule; and generating a moving image to be displayed on a display device that is provided in a vehicle cabin of the autonomous vehicle. The control unit generates the traveling plan or the moving image, such that at least a part of a behavior of the autonomous vehicle when the autonomous vehicle travels in accordance with the traveling plan and at least a part of the moving image to be displayed on the display device during traveling are coordinated with each other.

### INCORPORATION BY REFERENCE

The disclosure of Japanese Patent Application No. 2019-096229 filed on May 22, 2019 including the specification, drawings and abstract is incorporated herein by reference in its entirety.

### BACKGROUND

### 1. Technical Field

The disclosure relates to an information processing device, an autonomous vehicle, an information processing method and a program.

### 2. Description of Related Art

In recent years, technologies relevant to vehicles that can perform autonomous traveling have been developed. For example, Japanese Patent Application Publication No. 2017-222271 describes an information providing device that detects the orientation of the face of an occupant at a driver's seat, and displays a screen corresponding to a subtask, on a display disposed in a forward region including a region diagonally in front of the driver's seat, in the case of determining that the occupant at the driver's seat is executing the subtask. The subtask means an action such as watching a moving image including a movie and a TV program, listening to music, checking news, gaming, viewing a photograph or image data, using a social networking service (SNS), viewing a map, and reading a book.

### SUMMARY

The disclosure has an object to provide a more entertaining experience to a riding user in a vehicle that can perform autonomous traveling.

An information processing device according to a first aspect of the disclosure includes a control unit that executes: generating a traveling plan for an autonomous vehicle, the traveling plan including a traveling route and a traveling schedule; and generating a moving image to be displayed on a display device that is provided in a vehicle cabin of the autonomous vehicle. The control unit generates the traveling plan or the moving image, such that at least a part of a behavior of the autonomous vehicle when the autonomous vehicle travels in accordance with the traveling plan and at least a part of the moving image to be displayed on the display device during traveling are coordinated with each other.

In an information processing method according to a second aspect of the disclosure, a computer executes: generating a traveling plan for an autonomous vehicle, the traveling plan including a traveling route and a traveling schedule; and generating a moving image to be displayed on a display device that is provided in a vehicle cabin of the autonomous vehicle. The computer generates the traveling plan or the moving image, such that at least a part of a behavior of the autonomous vehicle when the autonomous vehicle travels in accordance with the traveling plan and at least a part of the moving image to be displayed on the display device during traveling are coordinated with each other.

A program according to a third aspect of the disclosure causes a computer to execute: generating a traveling plan for an autonomous vehicle, the traveling plan including a traveling route and a traveling schedule; and generating a moving image to be displayed on a display device that is provided in a vehicle cabin of the autonomous vehicle. The computer generates the traveling plan or the moving image, such that at least a part of a behavior of the autonomous vehicle when the autonomous vehicle travels in accordance with the traveling plan and at least a part of the moving image to be displayed on the display device during traveling are coordinated with each other.

With the disclosure, it is possible to provide a more entertaining experience to a riding user in a vehicle that can perform autonomous traveling.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a block diagram schematically showing an exemplary functional configuration of a vehicle according to an embodiment;

FIG. 2 is a flowchart showing an exemplary moving image generation process;

FIG. 3 is a diagram for describing a traveling plan and a moving image;

FIG. 4 is a diagram for describing a traveling plan;

FIG. 5 is a diagram for describing the moving image;

FIG. 6 is a flowchart showing an exemplary moving image display process that is executed during traveling of a vehicle;

FIG. 7 is a flowchart showing a modification of the moving image generation process; and

FIG. 8 is a diagram showing a schematic configuration of a system according to a modification.

### DETAILED DESCRIPTION OF EMBODIMENTS

An information processing device according to a first embodiment of the disclosure generates a traveling plan for a vehicle (also referred to as an “autonomous vehicle”) that can perform autonomous traveling, and generates data for a moving image that is watched within the vehicle by an occupant, a user of the autonomous vehicle. The traveling plan includes a traveling route along which the autonomous vehicle travels, and a traveling schedule that includes estimated times of arrivals at spots on the traveling route. Further, the information processing device generates the traveling plan or the moving image, such that at least a part of a behavior of the autonomous vehicle when the autonomous vehicle travels in accordance with the traveling plan and at least a part of moving image to be generated are coordinated with each other.

In the interior of the autonomous vehicle, a display device is provided. Examples of the display device include a liquid crystal monitor or touch panel that is provided on an instrument panel or the like, a projector that projects a picture on a screen, a head-up display that projects a picture on a windshield or a combiner, and a head mount display (HMD). The user can watch the moving image displayed on the display device.

The moving image is a picture content such as a movie, a two-dimensional or three-dimensional computer graphics (CG) animation and a virtual reality (V R) moving image. The information processing device according to the embodiment may draw the moving image based on a predetermined algorism, or may generate a single moving image by joining at least a part of existing moving image data as materials. The information processing device may generate the moving image as a program in a programming environment suitable for image processing or animation output, for example, in a programming environment with Processing, and may play back the moving image by executing the program. In each case, the information processing device generates at least a part of the content of the moving image, such that the at least a part of the content of the moving image is coordinated with at least a part of the behavior of the autonomous vehicle during the traveling of the autonomous vehicle. The behavior may be a change in the acceleration, deceleration, yaw rate, pitch rate or roll rate that is applied to the autonomous vehicle. For example, the information processing device may generate a moving image resulting from drawing a manner in which a movement route on the moving image is curved or some kind of character acts at the timing when the autonomous vehicle turns at an intersection based on a traveling route to a previously set destination.

For example, the content of the moving image may be a pseudo traveling moving image in which a surrounding landscape changes by moving a viewpoint (camera) from an occupant's eye (also referred to as a first-person viewpoint) within a virtual space resembling a real or imaginary place including the sky, seafloor, space and others. Further, the moving image is not limited to the expression of the change in the landscape associated with the movement, that is, the expression of the so-called first-person viewpoint, and may be the expression of the action of some kind of character, or may be a moving image in which an abstract form, pattern or color, or the like changes so as to be coordinated with the behavior of the vehicle. Further, the moving image may be coordinated with not only the picture but also an acoustic effect that is output from an unillustrated speaker.

Further, the autonomous vehicle decides a traveling route from the current place to a destination that is input by the user, for example. A known method can be employed for search of the route using map information and position information about the autonomous vehicle.

With the above information processing device, the user that rides in the autonomous vehicle and that watches the moving image can enjoy a moving image in which the content changes so as to be coordinated with the acceleration received by the traveling. That is, the vehicle in which the user rides can provide a more entertaining experience to the user, while traveling on a driveway.

During the traveling of the autonomous vehicle, the information processing device may alter the content of the moving image, for example, in response to the behavior of the autonomous vehicle for performing a deceleration or a lane change depending on a congestion situation of a road or for dealing with a disturbance such as an avoidance of an obstacle on a road. For example, the information processing device may draw an obstacle or character that appears in a movement direction on the moving image, in real time, or may draw a change in viewpoint for avoiding the obstacle or character, in real time, in response to the disturbance that affects the behavior of the autonomous vehicle.

The traveling route may be decided in consideration of the production of the content of the moving image. For example, the user selects a genre or story of a moving image that the user hopes to watch, and a traveling route suitable for the selected genre or story is selected. For example, a route including a curve where a high acceleration is generated in the autonomous vehicle at a previously set important point of the content of the moving image, a route including an unpaved road where vibration is generated, or the like may be purposely selected. Further, the autonomous vehicle may acquire congestion information about the road separately, and a route that is not congested may be selected in order to easily alter the acceleration, deceleration or steering angle of the autonomous vehicle for the important point of the content of the moving image.

A specific embodiment of the disclosure will be described below, based on the drawings. Unless otherwise mentioned, it is not intended to limit the technical scope of the disclosure, only to dimensions, materials, shapes, relative arrangements and others of constituent components that are described in the embodiment.

### Embodiment

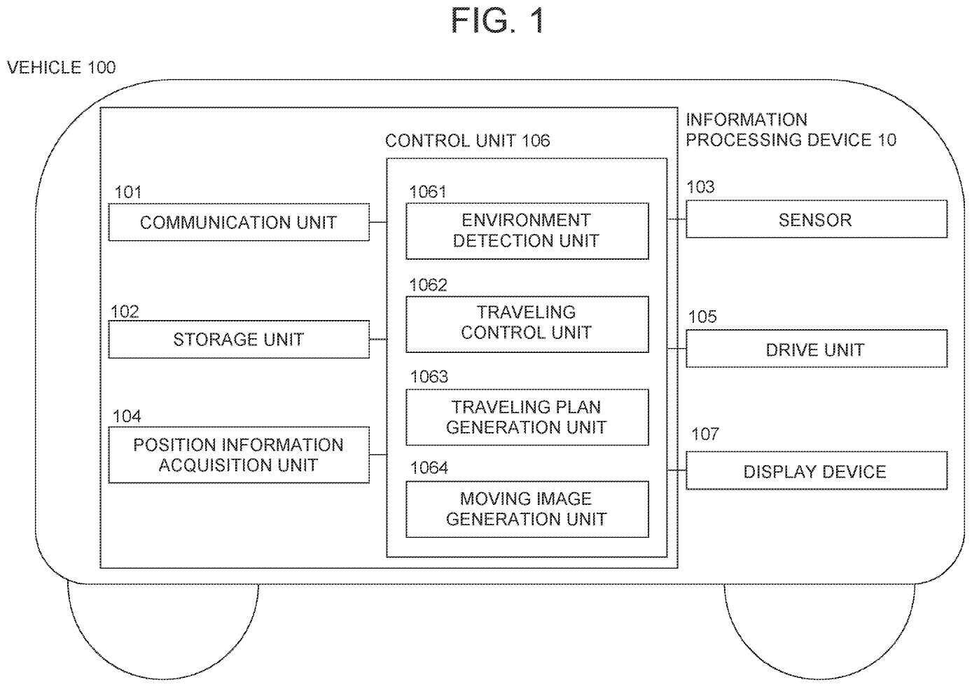

FIG. 1 is a block diagram schematically showing an exemplary functional configuration of a vehicle 100 according to the embodiment. The vehicle 100 is an autonomous vehicle that performs the autonomous traveling. The vehicle 100 is configured to include a communication unit 101, a storage unit 102, a sensor 103, a position information acquisition unit 104, a drive unit 105, a control unit 106 and a display device 107. For example, the communication unit 101, the storage unit 102, the position information acquisition unit 104 and the control unit 106 are included in the information processing device 10. The information processing device 10 is a so-called computer, and for example, the communication unit 101, the storage unit 102 or the position information acquisition unit 104 may be configured to be connected to the information processing device 10 as an external module. The vehicle 100 is an electric vehicle that uses a motor as a prime mover. However, the prime mover of the vehicle 100 is not limited to an electric motor, and may be an internal combustion engine. Further, the vehicle 100 may be a hybrid vehicle that includes both a motor and an internal combustion engine as the prime mover.

The communication unit 101 is a communication device for connecting the vehicle 100 to a network. The communication unit 101 can communicate with another server device and the like via the network, for example, using a mobile communication service such as 3rd Generation (3G) and Long Term Evolution (LTE). The vehicle 100 may acquire the map information and the congestion information about the driveway through the communication unit 101. The communication unit 101 may further include a communication device for performing inter-vehicle communication with another vehicle.

The storage unit 102 is a device in which information is stored in a transitory or non-transitory manner, and is constituted by a storage medium such as a magnetic disk and a flash memory. For example, the map information and the congestion information about the driveway are stored in the storage unit 102. Further, the destination as a place to which the user goes, the traveling plan for the vehicle 100 that is generated by a later-described traveling plan generation unit 1063, and the moving image that is generated by a later-described moving image generation unit 1064 are stored in the storage unit 102.

The sensor 103 is a device for sensing the situation surrounding the vehicle 100. Specifically, the sensor 103 is configured to include a stereo camera, a laser scanner, a LIDAR, a radar and the like. Information that is relevant to the situation surrounding the vehicle 100 acquired by the sensor 103 is sent to the control unit 106. The position information acquisition unit 104 is a device that acquires the current position of the vehicle 100, and is specifically configured to include a global positioning system (GPS) receiver and the like. Information that is relevant to the current position of the vehicle 100 acquired by the position information acquisition unit 104 is sent to the control unit 106.

The control unit 106 has a function to perform arithmetic processing for controlling the vehicle 100. For example, the control unit 106 is constituted by a microcomputer. The control unit 106 includes an environment detection unit 1061, a traveling control unit 1062, the traveling plan generation unit 1063 and the moving image generation unit 1064, as functional modules. Each of the functional modules may be realized when a processor such as a CPU executes a program stored in a storage unit such as a ROM that is included in the control unit 106. Further, some or all of the functions may be realized by hardware circuits such as an ASIC and a FPGA.

The environment detection unit 1061 detects the environment surrounding the vehicle 100, based on the information acquired by the sensor 103. For example, the environment detection unit 1061 detects a physical body (including a human and an animal) such as another vehicle that exists in an area surrounding the vehicle 100. Further, the environment detection unit 1061 detects various objects necessary for the autonomous traveling of the vehicle 100, as exemplified by the number and positions of lanes on the road, the structure of the road, and road signs. Further, the environment detection unit 1061 may perform the tracking of the detected physical body. In this case, for example, the relative speed of the physical body may be evaluated from a difference between coordinates of the physical body detected in the previous step and the current coordinates of the physical body.

The traveling control unit 1062 is a vehicle control device that controls the traveling of the vehicle 100 based on the traveling plan stored in the storage unit 102, the position information about the vehicle 100 acquired by the position information acquisition unit 104 and data about the surrounding environment detected by the environment detection unit 1061. For example, the traveling control unit 1062 causes the vehicle 100 to travel along the traveling route included in the traveling plan, in accordance with the traveling schedule included in the traveling plan. In the case where the environment detection unit 1061 detects a physical body with which the vehicle 100 can collide, the traveling control unit 1062 executes a collision avoidance control by which the vehicle 100 travels so as to avoid the collision with the physical body. As the method for the above autonomous traveling of the vehicle 100, a known method can be employed. Control information, a command generated by the traveling control unit for controlling the traveling of the vehicle 100 is output to the drive unit 105, and further is output to the moving image generation unit 1064.

The traveling plan generation unit 1063 generates the traveling plan for the vehicle 100, for example, using the map information and congestion information stored in the storage unit 102, the destination of the user, and the position information acquired from the position information acquisition unit 104. The traveling plan includes the traveling route and the traveling schedule. The traveling plan generation unit 1063 may decide the traveling route and the traveling schedule, in consideration of the production of the moving image.

The moving image generation unit 1064 generates the moving image to be displayed on the display device 107. The moving image generation unit 1064 generates the moving image, such that at least a part of the behavior of the vehicle 100 when the vehicle 100 travels in accordance with the traveling plan and at least a part of the moving image to be displayed on the display device 107 during the traveling are coordinated with each other.

The drive unit 105 is configured to include the motor that is the prime mover, and mechanisms (for example, an inverter, a brake and a steering mechanism) for the traveling of the vehicle 100. The drive unit 105 causes the vehicle 100 to travel based on the command generated by the traveling control unit 1062 for controlling the traveling of the vehicle 100. T hereby, the autonomous traveling of the vehicle 100 is realized.

The display device 107 is a picture output device provided in a vehicle cabin, and for example, is a liquid crystal monitor or touch panel provided on an instrument panel or the like, a projector that projects a picture on a screen, a head-up display that projects a picture on a windshield or a combiner, and a head mount display (HMD). In the case of the touch panel, the display device 107 also functions as an input device that accepts an operation by the user.

Processing Flow

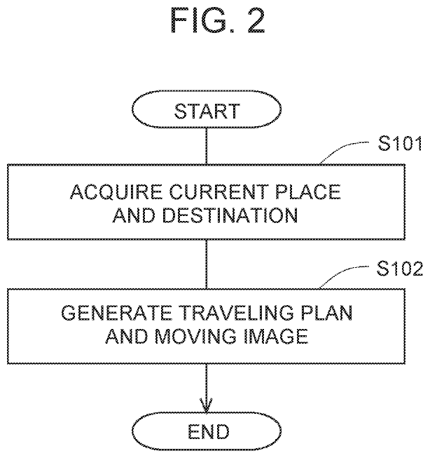

A process that is executed by the control unit 106 of the information processing device will be described below. FIG. 2 is a flowchart showing an exemplary moving image generation process. First, the traveling plan generation unit 1063 of the vehicle 100 acquires the position information, and acquires the destination of the user (FIG. 2: S101). The position information is acquired from the position information acquisition unit 104, for example, through the storage unit 102. The destination of the user is held in the storage unit 102, for example, based on an operation by the user.

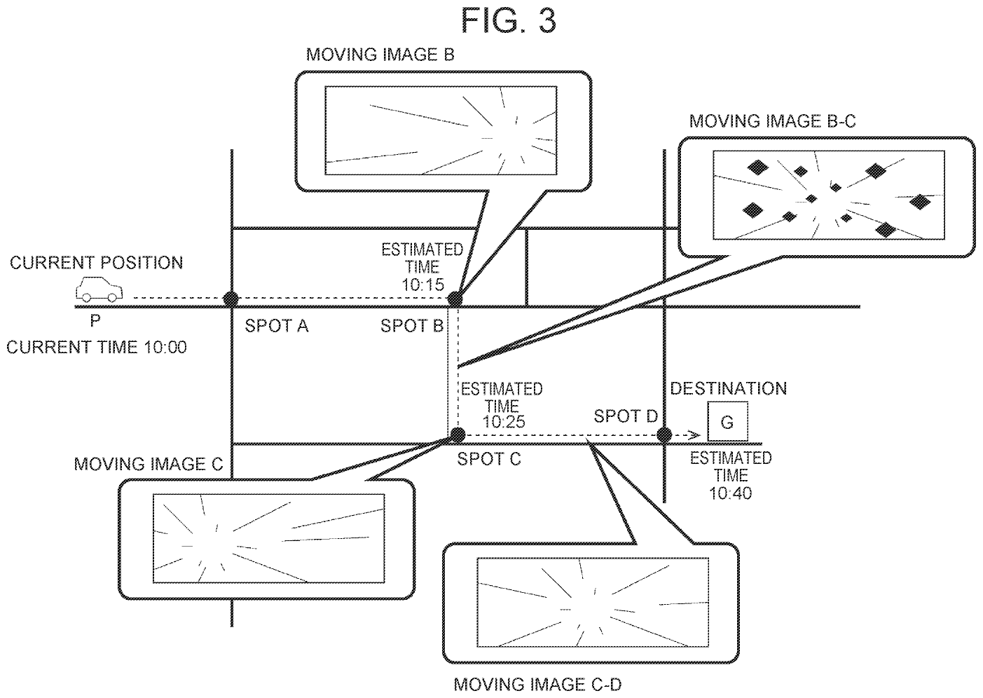

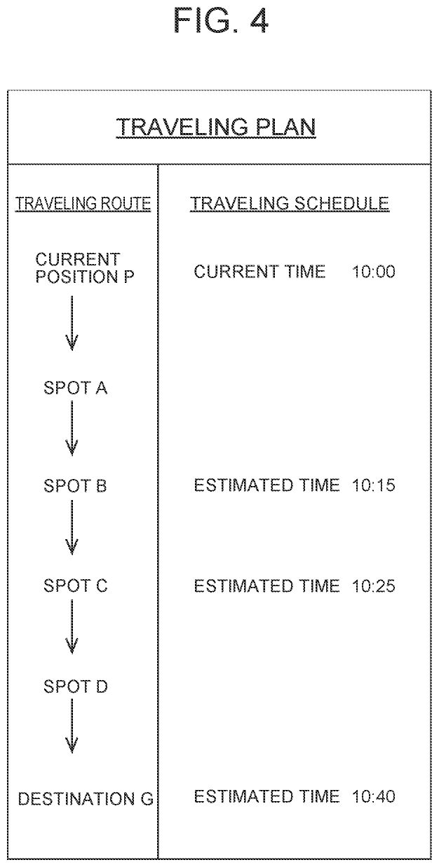

Then, the traveling plan generation unit 1063 generates the traveling plan, while the moving image generation unit 1064 generates the moving image (FIG. 2: S102). FIG. 3 is a diagram for describing the traveling plan and the moving image. FIG. 4 is a diagram for describing an example of the traveling plan. FIG. 3 shows a schematic map including a current position P and destination G of the vehicle 100. In FIG. 3, a dashed arrow indicates the traveling route of the vehicle 100 that is included in the traveling plan. The traveling route is information for uniquely specifying a road route, and may be stored in the storage unit 102, for example, as a data array that sequentially holds identification information indicating a branch point such as an intersection or position information including coordinates corresponding to a latitude and a longitude.

In FIG. 3, each of times written at passing spots and the destination on the traveling route is an example of the traveling schedule, and shows a predicted time when the vehicle 100 will pass through the spot or a predicted time when the vehicle 100 will arrive at the spot. The traveling schedule shown in FIG. 4 is calculated using a distance from the current place to the passing spot on the road and an estimated traveling speed at the passing spot on the road, for example, and is stored in the storage unit 102, as a data array that includes a plurality of combinations of information indicating the passing spot and an estimated passing time. Specifically, in FIG. 3, the vehicle 100 exists at the current position P at 10:00. In the case where the vehicle 100 moves to the destination G, the vehicle 100, in a plan, will turn right at a spot B, an intersection at 10:15, will turn left at a spot C, an intersection at 10:25, and will arrive at the destination G at 10:40. The traveling route from the current position P to the destination G is not limited to the route indicated by the dashed line in FIG. 3. That is, the traveling plan generation unit 1063 may generate the traveling plan, by selecting, as the traveling route, a route that makes it possible to provide a more entertaining experience to the user during the movement of the vehicle 100, from a plurality of routes from the current position P to the destination G. The traveling plan may be appropriately modified based on the congestion situation of the road and the like. The traveling control unit 1062 controls the vehicle 100, based on the above traveling plan including the traveling route and the traveling schedule.

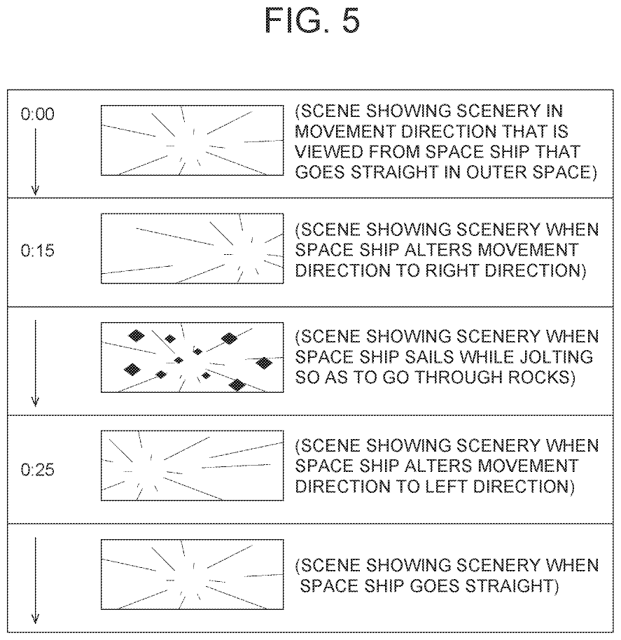

In FIG. 3, an image shown in each balloon expresses an exemplary scene of the moving image that is displayed on the display device 107 at the time point when the vehicle 100 travels at the passing spot on the traveling route. FIG. 5 is a diagram showing an example of the moving image. In FIG. 5, an elapsed time from the start of the playback is written to the left of each scene. That is, for 15 minutes from the start of the playback, a scene showing a scenery in the movement direction that is viewed from a space ship going straight in outer space is drawn. Then, at the time point of elapse of 15 minutes, a scene showing a scenery when the space ship alters the movement direction to the right direction is drawn. Thereafter, in a period before elapse of 25 minutes from the start of the playback, a scene showing a scenery when the space ship sails while jolting so as to go through rocks is drawn. Then, at the time point of elapse of 25 minutes, a scene showing a scenery when the space ship alters the movement direction to the left direction is drawn. Thereafter, after elapse of 25 minutes from the start of the playback, a scene showing a scenery when the space ship goes straight is drawn.

Based on the traveling route and the traveling schedule, for example, the moving image generation unit 1064 can calculate the timing of a change in the behavior including the acceleration, deceleration, yaw rate, pitch rate or roll rate of the vehicle 100, the direction of the change, and the amount of the change, and can generate a moving image in which the content of the picture to be watched by the user changes so as to be coordinated with the timing, the direction of the change and the amount of the change. For example, the moving image generation unit 1064 generates a moving image in which the content changes depending on a turning radius evaluated from the map information about the intersection and an estimated vehicle speed. That is, in FIG. 5, the movement direction of the viewpoint is altered so as to be coordinated with the right turn or left turn of the vehicle 100 on the traveling route, and the viewpoint is moved in the virtual space as the first-person viewpoint. For example, the moving image has a content in which the movement direction of the viewpoint in the moving image is changed to the right direction so as to be coordinated with the right turn of the vehicle 100 at the spot B after the elapse of 15 minutes from the start of the movement, which is a right turn included in the traveling plan, and the movement direction of the viewpoint in the moving image is changed to the left direction so as to be coordinated with the left turn of the vehicle 100 at the spot C after the elapse of 25 minutes from the start of the movement, which is a left turn included in the traveling plan.

For example, suppose that the road on the section between the spot B and the spot C is an unpaved road. It is predicted that the vehicle 100 traveling on the section will jolt wildly compared to a paved road. That is, the vehicle 100 generates a behavior such as a vertical acceleration or deceleration and a short-period fluctuation in the pitch or the roll, and in a time period when the vehicle 100 is estimated to travel on the section, the moving image generation unit 1064 generates the moving image showing the content in which the space ship on which a viewer rides sails in outer space so as to go through rocks (in FIG. 5, each of rhombic bodies in the figure showing the picture for 0:15 to 0:25 expresses a rock). The content of the moving image is not particularly limited as long as at least a part of the content of the moving image is coordinated with at least a part of the behavior of the vehicle 100. Preferably, the moving image should be a pseudo traveling moving image in which the surrounding landscape changes by moving the viewpoint expressed by the first-person viewpoint.

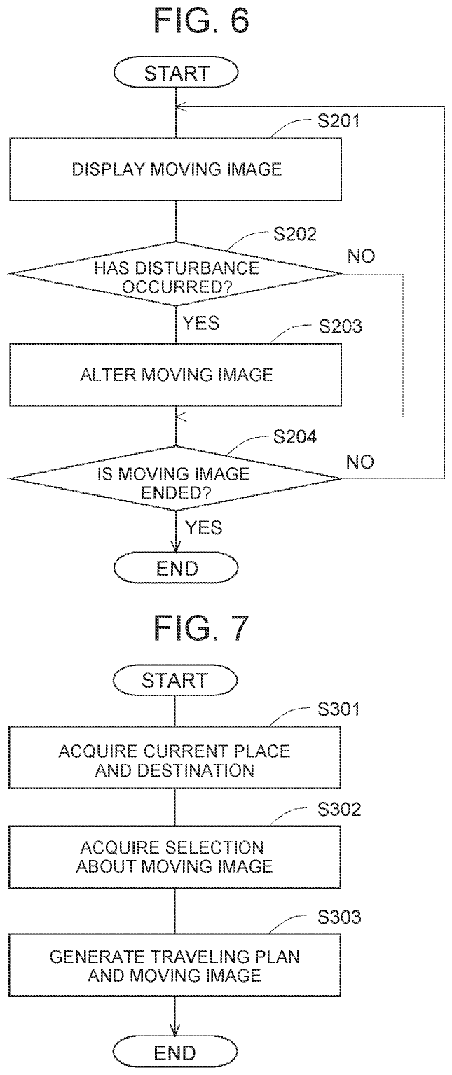

FIG. 6 is a flowchart showing an exemplary moving image display process that is executed during the traveling of the vehicle 100. During the traveling of the vehicle 100, the moving image generation unit 1064 displays the moving image on the display device 107 (FIG. 6: S201). In S201, as the data, the moving image based on the traveling plan and basically generated by the moving image generation process in FIG. 2 is output to the display device 107. Meanwhile, the traveling control unit 1062 causes the vehicle 100 to travel along the traveling route included in the traveling plan, in accordance with the traveling schedule. As a result, the content of the moving image and the behavior of the vehicle 100 are coordinated with each other.

During the traveling of the vehicle 100, the moving image generation unit 1064 determines whether a disturbance has occurred (FIG. 6: S202). For example, in the case where the environment detection unit 1061 detects a physical body with which the vehicle 100 can collide, the traveling control unit 1062 executes the collision avoidance control by which the vehicle 100 travels so as to avoid the collision with the physical body. In the case where the traveling control unit 1062 controls the traveling in response to the surrounding situation in this way, the moving image generation unit 1064 determines that the disturbance has occurred. For example, the environment detection unit 1061 may detect the acceleration, deceleration or yaw rate that is applied to the vehicle 100, and the moving image generation unit 1064 may determine that the disturbance has occurred in the case where the detected acceleration, deceleration or yaw rate is equal to or higher than a predetermined threshold.

In the case where it is determined in S202 that the disturbance has occurred (S202: YES), the moving image generation unit 1064 alters the moving image in response to the disturbance (FIG. 6: S203). In S203, for example, the moving image generation unit 1064 alters the content of the moving image depending on the acceleration, deceleration or yaw rate that is applied to the vehicle 100, and draws the moving image. For example, in the case where the movement direction of the vehicle 100 is altered for avoidance of another vehicle that is parked, the moving image generation unit 1064 may draw a moving image having a content in which an attack from some kind of obstacle or a character that appears is avoided, in real time. In this way, the moving image may be appropriately altered depending on the actual situation of the road.

After S203 or in the case where it is not determined in S202 that the disturbance has occurred (S202: NO), the moving image generation unit 1064 determines whether the generation and output of the moving image are ended (FIG. 6: S204). In S204, the moving image generation unit 1064 determines that the generation and output of the moving image are ended, for example, in the case where the user has performed an operation of stopping the playback of the moving image, or in the case where the vehicle 100 has arrived at the destination. In the case where it is determined that the generation and output of the moving image are ended (S204: YES), the moving image display process is ended. On the other hand, in the case where it is determined that the generation and output of the moving image are not ended (S204: NO), the moving image generation unit 1064 returns to S201 to repeat the process, and continues the playback of the moving image generated by the moving image generation process together with the traveling plan.

Modification 1

FIG. 7 is a flowchart showing a modification of the moving image generation process. In the modification, the type or story of the moving image that the user hopes to watch is further stored in the storage unit 102. As the type or story of the moving image, a plurality of types or stories may be previously prepared, and for each of the plurality of types or stories, content information including the acceleration, deceleration, yaw rate, pitch rate, roll rate or the like that needs to be generated in the vehicle 100 may be defined. Further, in the content information, the order or time period of the generation of the acceleration, deceleration, yaw rate, pitch rate or roll rate in the vehicle 100 may be set. In the modification, by using the content information in which the production is defined in this way and that is expressed as a so-called moving image continuity, it is possible to select the traveling route in accordance with a picture content in which a story line is previously set.

The traveling plan generation unit 1063 of the vehicle 100 acquires the position information, and acquires the destination of the user (FIG. 7: S301). S301 is the same as S101 shown in FIG. 2.

Next, the traveling plan generation unit 1063 acquires information indicating the selection about the moving image by the user (FIG. 7: S302). For example, in response to an operation by the user, the selection of the genre or story of the moving image that the user hopes to watch is previously received, and is held in the storage unit 102. Further, the production of the content of the moving image is defined, and is previously held in the storage unit 102, in association with the genre or story of the moving image. For example, the user selects the moving image of the space ship that sails in outer space. The moving image of the space ship includes a production in which the space ship sails so as to go through rocks, in the middle of the tale, and this scene is defined such that a behavior such as a short-period fluctuation in the yaw rate, a vertical acceleration or deceleration, or a short-period fluctuation in the pitch or the roll needs to be generated in the vehicle 100.

Thereafter, the traveling plan generation unit 1063 generates the traveling plan, and the moving image generation unit 1064 generates the moving image (FIG. 7: S303). S303 is nearly the same as S102 shown in FIG. 2. However, the traveling plan generation unit 1063 decides the traveling route, in consideration of the production of the moving image. For example, a traveling route that allows a desired behavior to be generated in the vehicle 100 at a previously set important point of the content of the moving image is selected. Accordingly, a route including a curve where a high acceleration is generated in the autonomous traveling vehicle, a route including an unpaved road where vibration is generated, or the like can be purposely selected. For example, in the case where the user selects the above-described moving image of the space ship, a route including an unpaved road where a behavior such as a vertical acceleration or deceleration and a short-period fluctuation in the pitch or the roll can be generated in the vehicle 100 can be selected.

With the modification, it is possible to select a traveling route that easily realizes the behavior of the vehicle 100 in accordance with a previously set scenario of the moving image.

Modification 2

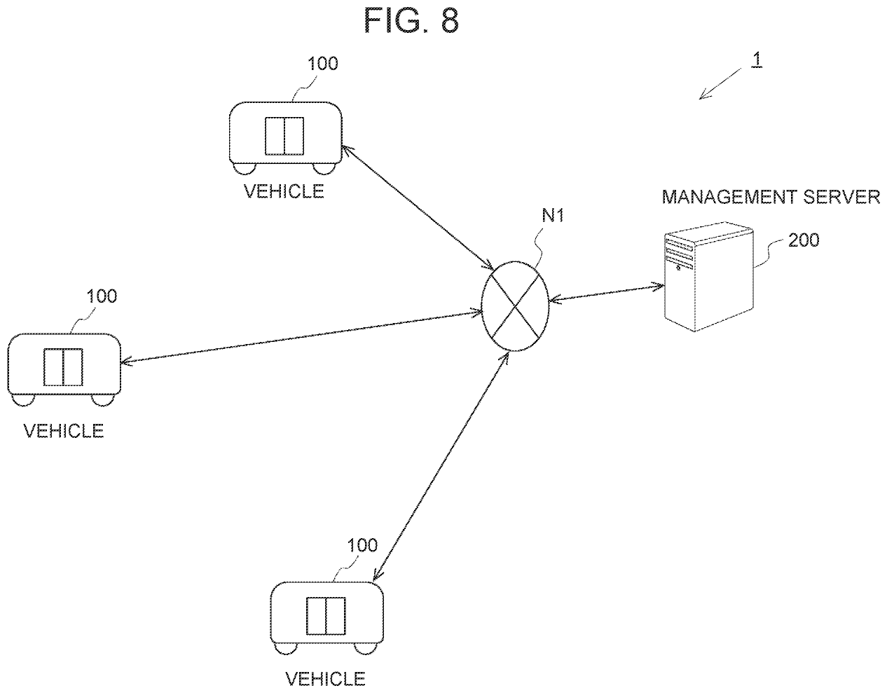

FIG. 8 is a diagram showing a schematic configuration of a system according to a modification. A system 1 is configured to include a plurality of vehicles 100 that can perform the autonomous traveling, and a management server 200. In the vehicle management system 1, each vehicle 100 and the management server 200 are connected to each other through a network N1. As the network N1, for example, a wide area network (WAN), a world-scale public communication network such as the internet, or a telephone communication network such as a mobile telephone network may be employed.

In the modification, the traveling plan and the moving image are generated by the management server 200, and is sent to the vehicle 100 through the network N1. That is, the functions of the traveling plan generation unit 1063 and moving image generation unit 1064 of the control unit 106 shown in FIG. 1 are realized by the management server 200, an information processing device.

For at least some of the functional blocks shown in FIG. 1, a plurality of devices may realize different functions in cooperation, or a plurality of devices may execute an identical function in parallel.

### Other Embodiments

Each of the above embodiment and modifications is just an example, and the disclosure can be carried out while being appropriately modified without departing from the spirit of the disclosure. Further, the processes and means described in the disclosure can be carried out while being freely combined as long as there is no technical inconsistency.

A process described as a process that is performed by a single device may be executed by a plurality of devices in cooperation. Alternatively, a process described as a process that is performed by different devices may be executed by a single device. In the computer system, a hardware configuration (server configuration) to realize each function can be flexibly modified.

The disclosure can be realized, also when a computer program in which the functions described in the above embodiment are implemented is supplied to a computer and one or more processors included in the computer read and execute the computer program. The computer program may be provided to the computer through a non-transitory computer-readable storage medium that can be connected to a system bus of the computer, or may be provided to the computer through a network. Examples of the non-transitory computer-readable storage medium include an arbitrary type of disk such as a magnetic disk (a Floppy® disk, a hard disk drive (HDD) and the like) and an optical disk (a CD-ROM, a DV D disk, a Blu-ray disk and the like), a read only memory (ROM), a random access memory (RAM), an E PROM, an EEPROM, a magnetic card, a flash memory, an optical card, and an arbitrary type of medium suitable for storing electronic instructions.

What is claimed is:

1. A n information processing device comprising a control unit that executes:
generating a traveling plan for an autonomous vehicle, the traveling plan including a traveling route and a traveling schedule; and
generating a moving image to be displayed on a display device that is provided in a vehicle cabin of the autonomous vehicle, wherein
the control unit generates the traveling plan or the moving image, such that at least a part of a behavior of the autonomous vehicle when the autonomous vehicle travels in accordance with the traveling plan and at least a part of the moving image to be displayed on the display device during traveling are coordinated with each other.

2. The information processing device according to claim 1, wherein:
the control unit generates control information with which the behavior of the autonomous vehicle during the traveling is controlled; and
the control unit alters the moving image during the traveling of the autonomous vehicle, based on the control information, such that the moving image is coordinated with the behavior of the autonomous vehicle.

3. The information processing device according to claim 1, wherein:
the control unit acquires content information including an acceleration, a deceleration, a yaw rate, a pitch rate or a roll rate that needs to be generated in the autonomous vehicle so as to correspond to a content of the moving image; and
the control unit generates the traveling plan based on the content information, such that the acceleration, the deceleration, the yaw rate, the pitch rate or the roll rate that is generated in the autonomous vehicle during the traveling corresponds to the content of the moving image at least at a time point.

4. A n autonomous vehicle comprising:
the information processing device according to claim 1; and
the display device.

5. An information processing method in which a computer executes:
generating a traveling plan for an autonomous vehicle, the traveling plan including a traveling route and a traveling schedule; and
generating a moving image to be displayed on a display device that is provided in a vehicle cabin of the autonomous vehicle, wherein
the computer generates the traveling plan or the moving image, such that at least a part of a behavior of the autonomous vehicle when the autonomous vehicle travels in accordance with the traveling plan and at least a part of the moving image to be displayed on the display device during traveling are coordinated with each other.

6. A program that causes a computer to execute:
generating a traveling plan for an autonomous vehicle, the traveling plan including a traveling route and a traveling schedule; and
generating a moving image to be displayed on a display device that is provided in a vehicle cabin of the autonomous vehicle, wherein
the computer generates the traveling plan or the moving image, such that at least a part of a behavior of the autonomous vehicle when the autonomous vehicle travels in accordance with the traveling plan and at least a part of the moving image to be displayed on the display device during traveling are coordinated with each other.
